(19) United States
(12) Patent Application Publication
(10) Pub. No.: US 2002/0151329 A1
(43) Pub. Date: Oct. 17, 2002

(54) Wireless telephone coupler

(76) Inventors: Paul R. Prince, San Juan Capistrano, CA (US); Rod E. Hosilyk, Reno, NV (US); Kevin R. Prince, Reno, NV (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/072,633

(22) Filed: Feb. 7, 2002

Related U.S. Application Data
(60) Provisional application No. 60/266,993, filed on Feb. 7, 2001.
(60) Provisional application No. 60/269,046, filed on Feb. 15, 2001.

(51) Int. Cl. H04M 1/00

(52) U.S. Cl. 455/557; 455/569

(57) ABSTRACT

A wireless telephone coupler for connecting a modem connected to a computer to a wireless telephone. In the preferred embodiments, the coupler includes an standard RJ-11 telephone jack for connection to the modem and a three conductor output receptacle adapted to be connected to the socket currently included in most cell phones and cordless phones for use with headsets to allow hands-free voice communication. In one preferred embodiment, a pair of amplifiers are coupled so that one of the amplifiers is coupled to transmit from the modem to one conductor of the socket and the other of the amplifier is connected to receive from the other of conductor and pass signals from the socket to the modem.

### PRIORITY CLAIM

This application claims the benefit of U.S. Provisional Application No. 60/266,993 filed Feb. 7, 2001 entitled “Cellular Telephone Coupler,” the entire content of which is expressly incorporated by reference, and U.S. Provisional Application No. 60/269,046 filed Feb. 15, 2001 entitled “Cellular Telephone Coupler,” the entire content of which is expressly incorporated by reference.

### FIELD OF THE INVENTION

This invention relates to telecommunications and more particularly to providing data access to the Internet and other networks, and to providing facsimile communication, all via wireless telephones.

### BACKGROUND OF THE INVENTION

Computers and facsimile machines are commonly enabled to communicate over the Public Switched Telephone Network (PSTN) through modems interfacing between them and standard 2-wire telephone lines. Situations occur wherein a telephone is available but connection to the telephone line, such as through an RJ-11 modular connector, is not, as in the case of public pay phones and telephones connected to PBX systems. In such cases acoustic coupling devices have been developed as described in Gutzmer U.S. Pat. No. 5,134,649. Gutzmer in U.S. Pat. No. 4,907,267 and U.S. Pat. No. 5,455,859 teaches interfacing devices for connecting modems to PBX and PSTN-connected base telephone instruments through the four-wire handset connectors such as RJ-9 modular jacks.

### SUMMARY OF THE INVENTION

The preferred embodiments of the present invention provide a wireless telephone coupler enabling wireless telephones to be connected to any portable or fixed data device such as a computer having a modem. Wireless telephones include, but are not limited to, the well-known household and industrial ‘cordless’ phones which communicate with Radio Frequency (RF) electromagnetic waves to a single local base unit, and mobile ‘cell phones’ which communicate, typically at greater distances and with many users, using RF electromagnetic waves to one or more fixed location cells in a matrix of cells making up a cellular network such as the widespread analog network “Advance Mobile Phone Service (AMPS)” serving a large number of customers and providing hand-off of calls from one cell to another as the mobile customer moves within the covered region.

A significant feature of the preferred embodiments is that the electrical connections to the wireless telephone do not ordinarily require any physical modification to the telephone unit. Rather, electrical connection to the wireless telephone is made via its “hands-free” circuitry. Many wireless telephones, including cell phones and cordless phones, have a hands-free jack such as a three-conductor triaxial 2.5 mm socket for use with headsets to allow hands-free voice communication. Some cell phones have a somewhat smaller socket and some require an adapter to their proprietary interface connectors for use with hands-free headsets. Generally such adapters are readily available at low-cost. Using this invention, the computer modem is connected via the wireless telephone to a distant modem to obtain distant data through the PSTN or other communication network. The computer is thus enabled to communicate data through the voice channel with a distant modem for Internet access using a wireless telephone without expensive special Internet Service Provider (ISP) monthly charges for data service and without special data cables unique to particular cell phones, which often require licensing agreements and associated costs.

Another significant feature of the preferred embodiments of this invention is that they do not require audio coupling transformers, thereby enabling reduced size, weight and cost.

Additional important advantages of the preferred embodiments is provision for RF shielding and/or filtering to protect against interference from RF transmissions and RF conductance from the adjoined wireless telephones, and RF emissions and conductance from the adjoined computers.

### BRIEF DESCRIPTION OF THE DRAWINGS

FIG. 1 is a general block diagram of a preferred embodiment of the invention;

FIG. 2 is an exploded perspective illustration of one embodiment of a wireless telephone coupler;

FIG. 3 is block diagram of the functional elements of the electronics of one embodiment of the invention;

FIGS. 4A and 4B show a detailed electronic schematic diagram of one embodiment of the wireless telephone coupler;

FIG. 5 is an enlarged view of illustrates a typical 2.5 mm cable plug useable with the certain preferred embodiments of the invention;

FIG. 6 illustrates a schematic diagram for an inverting cable for connecting a wireless telephone coupler to a wireless telephone; and

FIG. 7 is a connection table for the inverting cable of FIG. 6.

### DETAILED DESCRIPTION OF THE PREFERRED EMBODIMENT

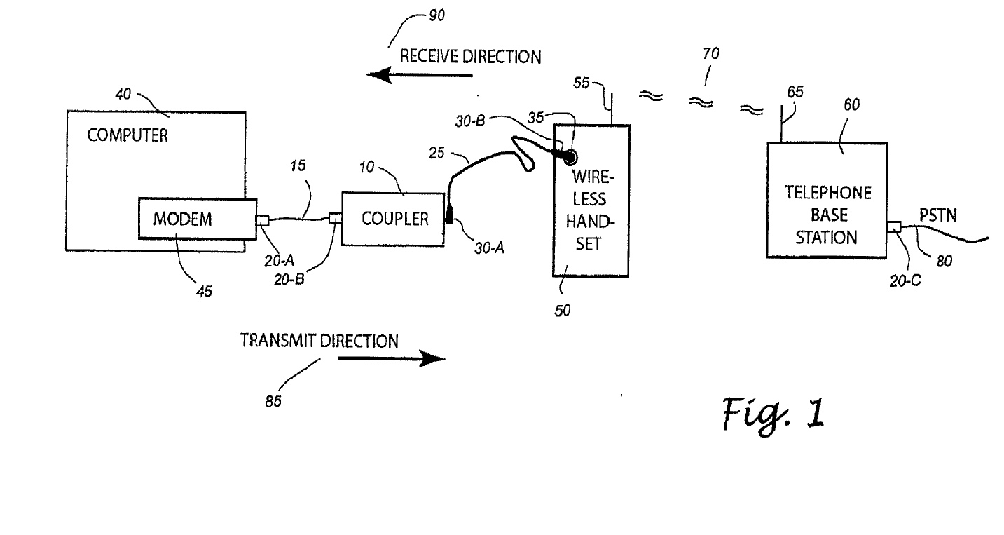

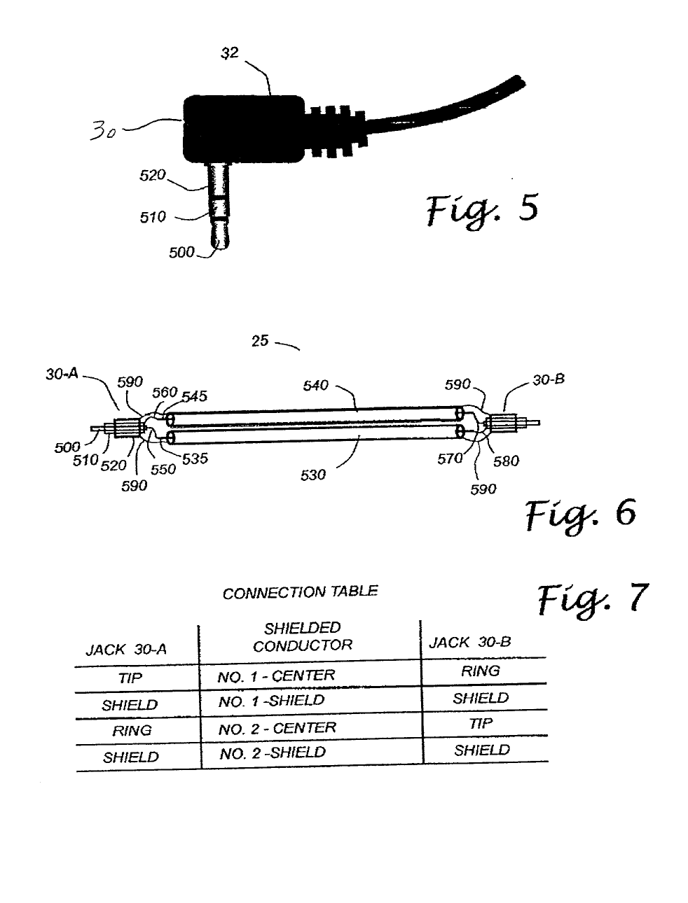

Referring to FIG. 1, the overall system of one preferred embodiment of the invention includes a wireless telephone coupler 10 having a two wire input connected to a modem lead 15 which includes standard telephone RJ-11 modular jacks 20 on each end. Coupler 10 has a two-signal output connecting to plug 30-A at one end of cable 25. The other end of cable 25 is connected to a plug 30-B. Plug 30-B is inserted into the standard hands-free headset socket 35. A three-conductor triaxial 2.5 mm socket is standard in many wireless telephones. However, the preferred embodiments of the invention can be adopted for use with other “hands-free” circuitry including sockets smaller or larger than the 2.5 mm socket or with interface adapters as described above. As described below, cable 25 may advantageously be the inverting cable shown in FIG. 6.

Plug 30-B is adapted to be inserted into the headset socket 35 of the wireless telephone handset 50 or an appropriate adapter connected thereto, not shown, for adapting handset 50 for hands-free headset use. RJ-11 modular jack 20 is adapted to be inserted into the mating RJ-11 telephone socket of a computer modem 45. This modem may be a separate component but is oftentimes incorporated within the digital computer 40.

Exemplary embodiments of computer 40 are portable computers such as laptop computers or hand-held computers, or larger office and home PC's and MACs, and may be other instruments such as facsimile machines, portable business and sales/service instruments for field inventory, service call reporting, invoicing, parts downloading, service call routing, and point-of-sales reporting, etc.; and cash registers that normally tie into PSTN for inventory control, credit card verification, and the like. Rural ATM machines and other information-communicating instruments not accessing the PSTN are additional applications of the present invention, including emergency use of wireless telephones for banks, ATM machines, sales desks, and the like when the PSTN is temporarily overloaded or inoperative and the communication services are vital. All of these applications, and others that will become obvious to those in the field, may benefit from the present invention. The term computer herein is taken to cover all such instruments, communication devices, machines, and may include a modem, either internally or externally located, and connected thereto.

Continuing with FIG. 1, audio signals initiated within modem 45 and conducted to coupler 10 are termed transmit signals and flow in transmit direction 85 according to conventional terminology in the telecommunications industry. Signals coming from the distant modem, not shown, via the PSTN 80, base station 60, radio waves 70, wireless handset 50, cable 25, coupler 10, and lead 15 to arrive at modem 45 are traveling in receive direction 90. As is well known, both transmit signals and receive signals are carried over the same wires or communication means of the telephone system. Transmit signals delivered to handset 50 enter the handset microphone interface at socket 35 through inverting cable 25. Such transmit signals are directed within handset 50 to a microphone amplifier, not shown. Coupler 10 is required to attenuate transmit signals in order to offset voltage gain of the microphone amplifier in order to avoid excessive signal amplitudes. Transmit and receive signals are communicated between handset 50 and telephone base station 60 through radio waves 70 generated and received between handset antenna 55 and base station antenna 65. Such radio waves 70 are generally in the Radio Frequency (RF) range between 40 MHz and 6000 MHz. Future RF communication links for wireless telephony may be outside of this range, yet be useable with the present invention.

Base station 60 may be a cordless telephone base such as in a home or business, a cordless telephone network servicing base, a cellular telephone cell communicating with a central cellular telephone system, or other telecommunication equipment. Base station 60 is connected to PSTN through cable 80 and may include RJ-11 modular jacks 20.

It will be understood by those skilled in the art that the preferred embodiments described herein are believed to be useful for all analog cellular networks. However, digital cellular networks often utilize non-linear coding and compression which generally prevent useful transmission of modem signals. Additional uses of the preferred embodiments are described below.

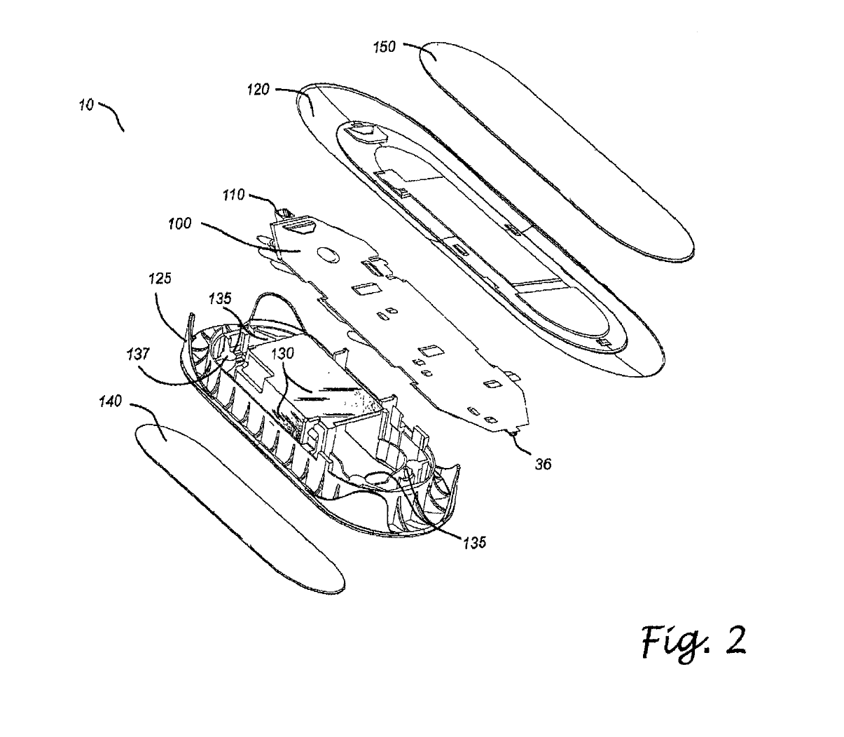

The drawing of FIG. 2 illustrates an exploded view of coupler 10 showing electronic circuit board 100 which includes RJ-11 socket 110 for connection to a modem, and a jack 36 for receiving plug 30-A. Additional components on circuit board 100 will be described below. Housing base 125 accepts a common 9-volt battery, not shown, and battery cover 140. Circuit board 100 is captured between lower housing 125 and upper housing 120, and the assembly is closed with upper cover 150.

In some applications the RF fields may be substantial and, in addition to RF filtering described below, will require extensive shielding of circuit board 100. Conductive coatings inside the housing to create a substantially RF-tight conductive enclosures or Faraday shield, may be applied using metallic deposition techniques well known in the art. Conductive coating 130 is partially illustrated within lower housing 125, and advantageously covers substantially all inner plastic surfaces except the top surfaces of four LED light pipes 135. Top light pipe surfaces 137 are light input surfaces that conduct LED emissions into the plastic structure to indicate the modem off-hook occurrence, which is an important feature described below. Other housing configurations of various shapes and designs may be used while employing this invention.

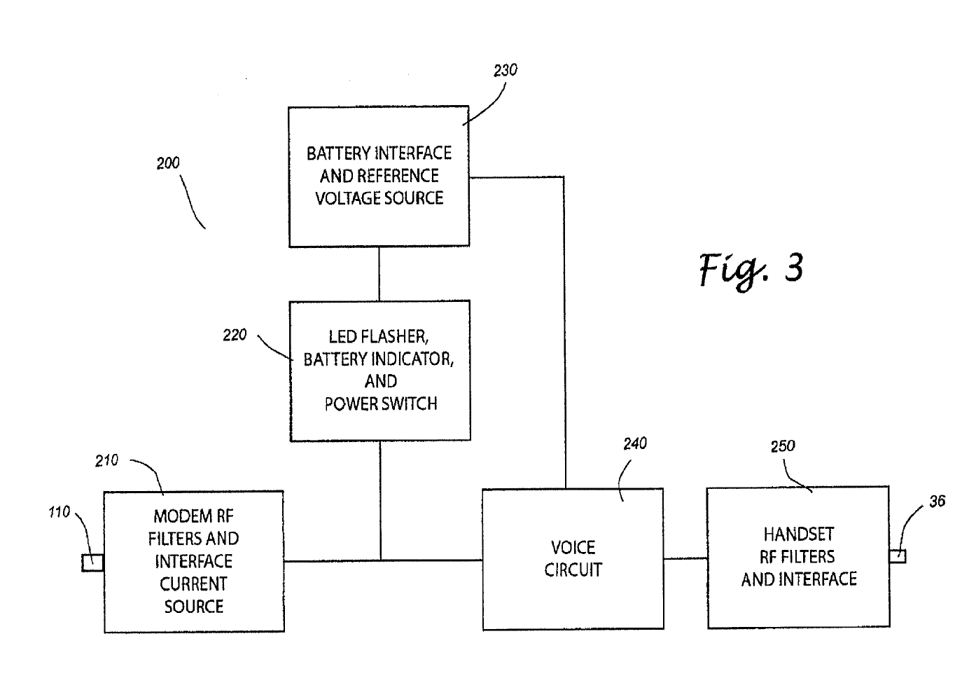

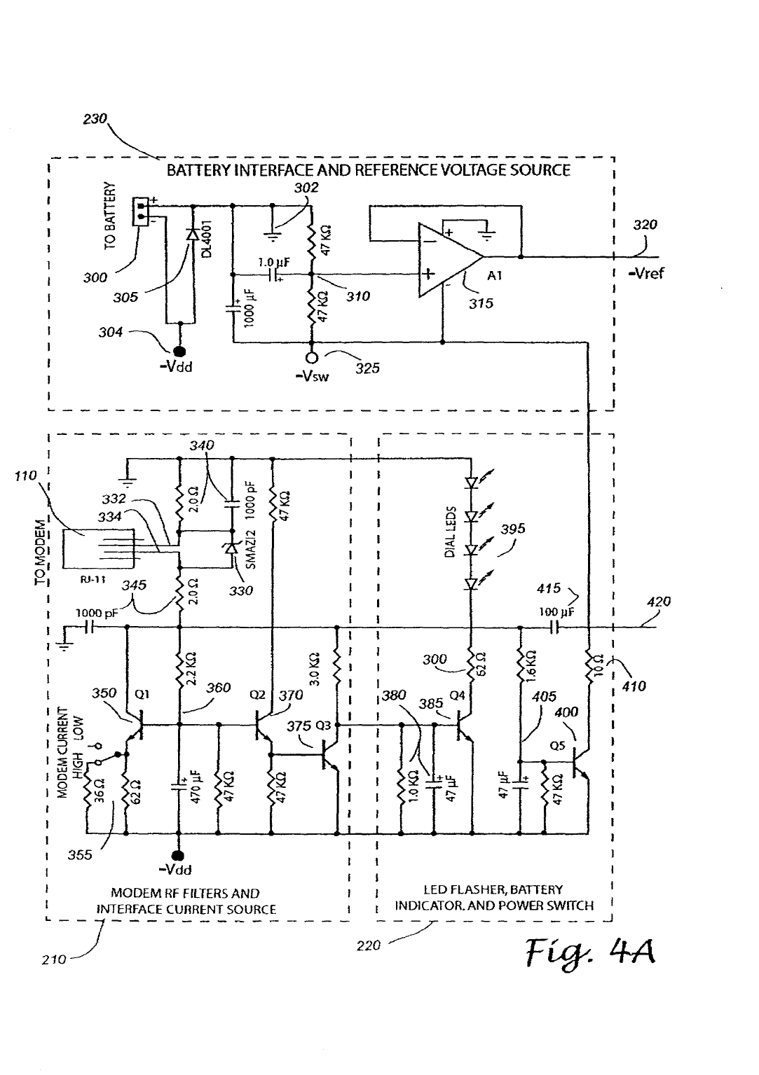

FIG. 3 depicts five major elements of electronics 200 of the coupler, including MODEM RF FILTERS AND INTERFACE CURRENT SOURCE 210 to reduce interference from RF fields and supply current required for modem operation via RJ-11 socket 110. LED FLASH, TIMER, BATTERY INDICATOR, AND POWER SWITCH 220 provide an LED visual indicator that flashes momentarily upon the event of the modem making it's connection, commonly referred to going off-hook. The intensity of the LED indicator is a measure of battery charge condition. BATTERY INTERFACE AND REFERENCE VOLTAGE SOURCE 230 provides power for the circuit and a reference voltage for biasing various elements to be discussed below. The above three major elements are described in detail in conjunction with FIG. 4A below.

The remaining two major elements in FIG. 3 are described in detail in FIG. 4B below. VOICE CIRCUIT 240 is a conversion circuit for connecting the audio output signal from the modem 45 to the hands-free input jack 35 of the handset 50. HANDSET RF FILTERS AND INTERFACE 250 includes transmit signal adjustments to adapt to a variety of telephone handset microphone gain characteristics, and filters to reduce interference from RF fields. In a preferred embodiment, any RF pickup is reduced to levels sufficiently low so that the RF signals are not detected in semiconductor junctions within electronics 200. Element 250 advantageously may include the 2.5 mm triaxial socket 36 compatible with many handset jacks or other connection to the “hands-free” circuitry as described above.

Referring to the electronic circuit diagram of FIG. 4A, connector 300 connects to a common 9-volt battery, not shown. Diode 305 protects the circuit from reverse voltage. Circuit ground 302 connects to the positive battery terminal and −Vdd 304 connects to the negative battery terminal. Divider network 310 divides and filters the supply voltage to generate a reference potential −Vref 320 buffered by voltage-follower 315 which may incorporate one of the integrated circuit operational amplifiers in a quad op-amp package MC33179DN, for example. The positive supply terminal of the amplifier package shown at voltage-follower 315 is connected to circuit ground and the negative supply terminal of the amplifier package is connected to a switched negative voltage −Vsw 325 substantially at the potential of −Vdd when a modem is connected and is off-hook.

RJ-11 socket 110 connects a modem first lead 332 to circuit ground through RF filter resistor-capacitor (RC) combination 340. Zener diode 330 is connected across the input leads from the modem and protects the coupler electronics in the event a user incorrectly connects that input into a telephone line. RC filter 345 reduces RF interference from the modem second lead 334. Many modems typically require a minimum dc current of approximately 8 to 20 milliamperes as would be available from a telephone line connected to the PSTN. This current is supplied to the modem from the coupler from its 9-volt battery. Transistor Q1 350 is a current source providing required modem off-hook holding current to maintain connection and may be one of the npn transistors in a five-transistor array such as CA3083M, or equivalent. Emitter resistors and switch 355 allow selection for high or low modem current to satisfy the specific modem requirements. Network 360 provides current source bias current and a timer function for the LED flasher. Transistor Q2 370 biases transistor Q3 375 following the LED timeout to act as a base-emitter voltage reference for the current source Q1 350. RC filter 380 insures LED driver Q4 385 is not modulated with modem signals. Resistor 300 and the four DIAL LEDs 395 establish the LED intensity as a function of battery voltage advantageously utilizing the rapid current cutoff of the red LEDs below approximately 1.7 volts each. Thus the LED indicator rapidly produces less light intensity as battery voltage drops to about 6.8 volts, close to the lower practical limit of battery life for the circuit. Transistor Q5 400 is driven into saturation through the bias and RC filter network 405 which also insures that modem signals do not vary the clamping action of Q5 to hold the switched supply −Vsw 325 substantially to −Vdd during the off-hook modem condition, whereas during on-hook modem conditions, that is, when the system is not in use, extremely low current is drawn from the 9-volt battery, and such battery may be left connected to the circuit for long periods of time. Audio modem signal at node 420, which includes transmit signals and receive signals, is AC coupled through capacitor 415 to the voice circuit described below.

FIG. 4B illustrates the remainder of the coupler electronics circuit diagram. VOICE CIRCUIT 240 substantially matches the modem nodal impedance at node 420 with RC circuit 430, and through transmit amplifier A3 445, provides a non-zero inverted X2 gain for transmit signals and a negative non-zero X1 gain for received signals. As a result, transmit amplifier 445 substantially nulls any receive signal passing to the output of A3 since the receive signal at receive amplifier A2 440 output is multiplied by substantially zero gain (1−1)=0 when RC circuit 430 matches the nodal impedance at node 420 for audio frequencies of interest, between approximately 100 Hz and approximately 4000 Hz. Any small mismatch, seen as a small echo signal, is easily eliminated by modem echo cancellers as is well known in the art. −Vref 320 through resistors 435 and 465 establishes amplifier bias values substantially midway between −Vsw and ground, minimizing any circuit distortion and maximizing dynamic range. Receive amplifier A2 440 provides a non-zero gain of approximately 1.5 for the signal at node 420 through input resistor 450 and feedback resistor 455, and the voltage drop across RC circuit 430. This gain is appropriate for wireless telephone handsets which typically include volume controls for adjusting the receive signal that is normally directed to a hands-free headset earpiece speaker, not shown. Such receive signal is, instead, directed to INTERFACE 250 at 35 on the TIP lead connected to RF filter 495 and thence to capacitor 460 for ac coupling to amplifier A2 440. The transmit signal from A3 is AC coupled to three attenuation resistors 470 while TRANSMIT GAIN switch 475 selects an appropriate attenuation for the instant telephone handset microphone amplifier connected thereto. The attenuation is established through voltage division of the selected resistor 470 and resistor 480 connected to −Vsw 325, which is utilized as the common ac ground shared between the transmit and receive signals and is connected to the socket 36 shield generally representing circuit ground within wireless handsets connected thereto. RF energy induced into the shield is bypassed to circuit ground with RC filter 485.

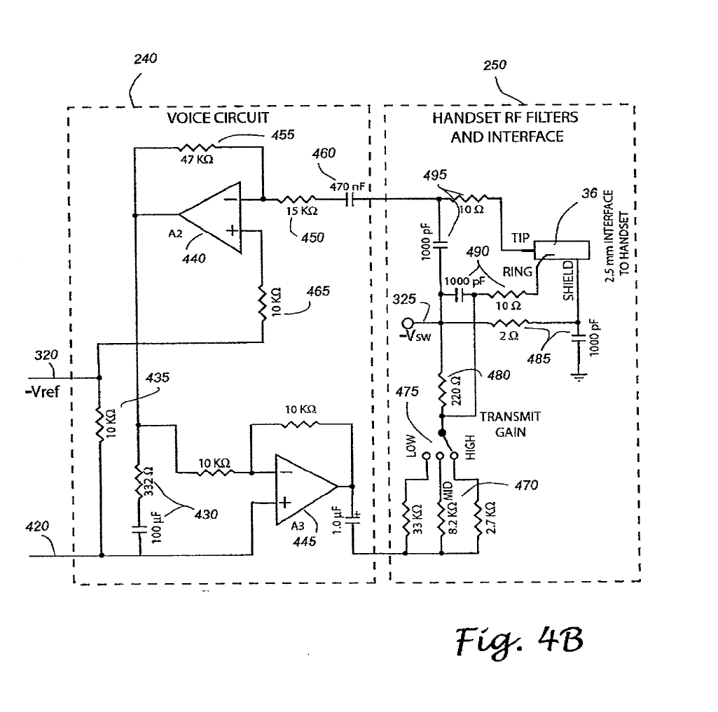

FIG. 5 illustrates a typical 2.5 mm hands-free headset plug 30 which includes molded cover 32, shield terminal 520, ring terminal 510, and tip terminal 500.

FIG. 6 is a connection diagram of a preferred inverting cable 25 which includes a plug 30 at each end, shielded conductor No. 1 530, shielded conductor No. 2 540, and connections of the inner conductors and shields to plugs 30. Reference may be made to both FIG. 6 and to FIG. 7 CONNECTION TABLE for understanding the connections of inverting cable 25. The TIP 500 contact of left plug 30-A is electrically connected with connection 550 to center conductor 535 of shielded conductor No. 1 530, which on the right end at 2.5 mm plug 30-B is connected to RING through connection 580. In similar fashion, plug 30-A RING 510 is connected to center conductor 545 of shielded conductor No. 2 540 through connection 560 and is connected at the right end at plug 30-B to the TIP terminal of plug 30-B with connection 570. Both shields at both ends are connected to the respective plug shields 520 with shield connections 590.

This inverting cable 25 is for use with couplers connecting the transmit signal to the RING terminal of socket 35 as shown in FIG. 4B. The convention for wireless hands-free headsets places the earpiece speaker handset output on the RING terminal at the handset socket, and the microphone handset input on the TIP terminal at the handset socket. If a hands-free headset, not shown, is plugged into the coupler socket 35 while connected to a modem and computer, modem tones may be heard in the hands-free headset, aiding a user while troubleshooting to confirm operation of the computer, modem, and coupler in the transmit direction. In this way a simple test mode of operation is provided.

The coupler to handset cable 25 may alternatively be non-inverting, not shown, as an alternate embodiment of this invention, in which case the coupler transmit output of RC filter 490 in FIG. 4B connects to the TIP terminal of socket 36 and the receive input at RC filter 495 connects to the RING terminal of socket 36. This combination, however, does not facilitate the convenient test mode described above.

Other embodiments, not illustrated, include the incorporation the wireless telephone coupler within the housing of a wireless telephone, eliminating cable 25 and two sockets 35 and 36, and providing the wireless telephone with an RJ-11 connector adapted for connection to a modem.

Although preferred processing circuitry has been described, other data processing circuits may advantageously be connected to the handset circuitry commonly provided by wireless telephones to pass data to and/or from such wireless telephones for data communications between computers and are also within the scope of this invention. Thus, while the invention has been described herein with reference to certain preferred embodiments, these embodiments have been presented by way of example only, and not to limit the scope of the invention. Accordingly, other embodiments and changes in form and detail may be made therein by one skilled in the art without departing from the spirit and scope of the invention, including embodiments which do not provide all of the benefits and features set forth herein.

What is claimed is:

1. A wireless telephone coupler for connecting a modem to a wireless communication path via the hands-free circuitry of a wireless telephone comprising:
an RJ-11 plug for connection to said modem;
an interface current source coupled to said RJ-11 plug; and
a voice circuit receiving the audio output signal of said modem, said voice circuit comprising:
(a) an RC input circuit substantially matching the nodal impedance of said modem;
(b) a socket having a shield, ring and tip conductor;
(c) a receiving amplifier having an input coupled to said tip conductor of said socket and an output coupled to said RC input circuit; and
(d) a transmit amplifier having an input coupled to said RC input circuit and an output coupled to said ring conductor of said socket, the gain of said transmit amplifier being (i) non-zero for audio modem signals received from said modem and (ii) approximately zero or sufficiently low for any signals at the output of said receiver amplifier so that any resulting echo does not interfere with the transmission of said audio modem signals through said voice circuit; and
(e) a signal inverter cable connecting said socket of said voice circuit to a wireless telephone comprising:
(a) a first and second plug each having a shield terminal, a ring terminal and a tip terminal;
(b) a first shielded conductor connected from the tip terminal of said first plug to the ring terminal of said second plug, said shield being connected to the shield terminal of both of said plugs; and
(c) a second shielded conductor connected from the ring terminal of said first plug to the tip terminal of said second plug, said shield being connected to the shield terminal of both of said plugs.

2. A wireless telephone coupler for connecting a modem to a wireless communication path via the hands-free circuitry of a wireless telephone comprising:
an RJ-11 plug for connection to said modem, an RF filter and interface current source coupled to said RJ-11 plug;
a voice circuit receiving the audio output signal of said modem, said voice circuit comprising:
(a) an input circuit substantially matching the nodal impedance of said modem;
(b) a socket having a shield, ring and tip conductor;
(c) a receiving amplifier having an input coupled to said ring conductor of said socket and an output coupled to said RC input circuit;
(d) a transmit amplifier having an input coupled to said audio RC input circuit and an output coupled to said tip conductor of said socket, the gain of said transmit amplifier being (i) positive for audio modem signals received from said mode and (ii) approximately zero or sufficiently low for any signals at the output of said receiver amplifier so that any resulting echo does not interfere with the transmission of said audio modem signals through said voice circuit; and
(e) a non-inverter cable connecting said socket of said voice circuit to a wireless telephone comprising:
(a) a first and second plug each having a shield terminal, a ring terminal and a tip terminal;
(b) a first shielded conductor connected from the tip terminal of one of said first plug to the tip terminal of said second plug, said shield being connected to the shield terminal of both of said plugs, and
(c) a second shielded conductor connected from the ring terminal of said first plug to the ring terminal of said second plug, said shield being connected to the shield terminal of both said plugs.

3. A wireless telephone coupler for connecting a data communications device to a wireless communication path via the hands-free circuitry of a wireless telephone comprising:
an input plug for connection to said data communications device; and
a voice circuit receiving the audio output signal of said data communications device, said voice circuit comprising:
(a) an input circuit substantially matching the nodal impedance of said data communications device;
(b) a multiple-conductor socket having a shield and first and second conductors;
(c) a receiving amplifier having an input coupled to one of said conductors of said multiple-conductor socket and an output coupled to said input circuit; and
(d) a transmit amplifier having an input coupled to said input circuit and an output coupled to the other of said conductors of said multiple-conductor socket, the gain of said transmit amplifier being (i) non-zero or negative for audio data communications device signals received from said data communications device and (ii) approximately zero or sufficiently low for any signals at the output of said receiver amplifier so that any resulting echo does not interfere with the transmission of said audio data communications device signals through said voice circuit.

4. The wireless telephone coupler of claim 3 wherein said handset circuitry includes a triaxial substantially 2.5 mm 3-conductor socket.

5. The wireless telephone coupler of claim 3 wherein said handset circuitry includes an adapter appropriate to a particular wireless telephone..

6. The wireless telephone coupler of claim 3, including an inverter cable connecting said socket of said voice circuit to a wireless telephone comprising:
(a) a first and second plug each having a shield terminal, a first terminal and a second terminal;
(b) a first shielded conductor connected from the first terminal of said first plugs to the second terminal of said second plug, said shield being connected to the shield terminal of both of said plugs; and
(c) a second shielded conductor connected from the second terminal of said first plug to the first terminal of said second plug, said shield being connected to this shield terminal of both of said plugs.

7. The wireless telephone coupler of claim 3, wherein said input plug is an RJ-11 plug.

8. The wireless telephone coupler of claim 3, including a cable connecting said socket to a wireless telephone includes at one end of said cable a substantially 2.5 mm plug for connecting to said handset socket of said wireless telephone.

9. The wireless telephone coupler of claim 3, wherein said input circuit substantially matching the nodal impedance of said data communications device includes electrical resistance and capacitance for closely matching the nodal impedance of said data communications device and cables connecting said data communications device to the coupler.

10. The wireless telephone coupler of claim 3, including an RF filter at the input of said voice circuit for substantially eliminating RF energy on the audio output conductor from said data communications device.

11. The wireless telephone coupler of claim 3, including a Zenior diode at the input of said coupler to protect said coupler in the event that a user incorrectly connects said input to a conventional telephone line.

12. The wireless telephone coupler of claim 3, including a battery source of d.c. current for said data communications device.

13. The wireless telephone coupler of claim 3, having a switch for selecting high or low data communications device current.

14. The wireless telephone coupler of claim 3, having a switch for selecting the appropriate attenuation of the coupler output signal for said wireless telephone.

15. The wireless telephone coupler of claim 3, including a clamping circuit for maintaining a battery supplied voltage only during the off-hook data communications device condition so that an extremely low current is drawn from said battery during on-hook data communications device conditions.

16. The wireless telephone coupler of claim 12, including a series of LEDs enabled to be coupled to said battery to indicate the voltage of said battery.

17. The wireless telephone coupler of claim 12 wherein is a cell phone operable in an analog cellular network.

18. The wireless telephone coupler of claim 12 wherein said wireless telephone is a cordless telephone.

19. The wireless telephone coupler of claim 12 wherein said data communications device is a computer having a modem.

20. A wireless telephone coupler for connecting a modem to a wireless communication path via the multiple-conductor circuit provided by wireless telephones for hands-free communication, said coupler comprising:
an input plug for connection to said modem; and
a circuit receiving the audio output signal of said modem, said circuit including:
(a) an input circuit substantially matching the nodal impedance of said modem;
(b) a receiving amplifier having an input coupled to one of said conductors of said multiple-conductor circuit and an output coupled to said input circuit; and
(c) a transmit amplifier having an input coupled to said input circuit and an output coupled to another of said conductors of said multiple-conductor circuit, the gain of said transmit amplifier being (i) non-zero for audio modem signals received from said modem and (ii) approximately zero or sufficiently low for any signals at the output of said receiver amplifier so that any resulting echo does not interfere with the transmission of said audio modem signals through said voice circuit.

21. A wireless telephone coupler for connecting a modem to a wireless communication path via circuitry provided by wireless telephones for hands-free communications, said coupler comprising:
an input plug for connection to said modem; and
a circuit receiving the audio output signal of said modem, said circuit comprising:
(a) a receiving amplifier having an input coupled to said hands-free circuitry and an output coupled to said input plug; and
(b) a transmit amplifier having an input coupled to said input plug and an output coupled to said hands-free circuitry, the relative gains of said amplifiers reducing any resulting echo sufficiently to not interfere with the transmission of said audio modem signals to said wireless telephone.

22. A method for testing a wireless telephone coupler adopted to connect a modem to a wireless communication path via the hands-free circuitry of a wireless telephone including:
coupling the output of a transmit amplifier to the one conductor of said hands-free circuit and the input of said transmit amplifier to the output of said modem;
coupling the input of a receiving amplifier to another conductor of said hands-free circuit; and
coupling a hands-free headset to the output of said transmit amplifier and the input of said receiving amplifier and determining that the audio modem signal is being received at said headset.

23. A wireless telephone coupler for connecting a modem to a wireless communication path via a wireless telephone comprising:
receiving amplifier means coupled between said wireless telephone and the output of said modem,
transmit amplifier means coupled between the output of said modem and said wireless telephone, said transmit amplifier having a non-zero positive or negative gain for audio frequency signals from said modem and substantially zero gain for signals at the output of said receiving amplifier, and
means coupling the output of said transmit amplifier and the input of said receiver amplifier to the hands-free handset socket or adapter interface of said wireless telephone.

24. A wireless telephone coupler for connecting a data communications device to a wireless communication path via the circuit provided by wireless telephones for hands free audio communication, said coupler comprising:
an input plug for connection to said data communications device;
an interface circuit to said device enabling communication to and from said data communications device; and
a conversion circuit for transmitting output data of said data communications device to said telephone and for receiving distant data from said telephone and directing said distant data to said data communications device, said conversion circuit including:
(a) a receive circuit having an input coupled to one of said conductors of said hands-free circuit and an output coupled to said interface circuit, the gain of said receive circuit being non-zero for any distant data signals at said input; and
(b) a transmit circuit having an input coupled to said input circuit and an output coupled to another of said conductors of said hands-free circuit, the gain of said transmit circuit being:
(i) non-zero for data signals received from said data communications device; and
(ii) substantially zero for any distant data signals at the output of said receive circuit.
